(19) United States
(12) Patent Application Publication
(10) Pub. No.: US 2002/0114507 A1
(43) Pub. Date: Aug. 22, 2002

(54) Saw alignment technique for array device singulation

(76) Inventors: Mark Lynch, Dana Point, CA (US); Matthew S. Read, Rancho Santa Margarita, CA (US); Robbie U. Villanueva, Rancho Santa Margarita, CA (US)

Correspondence Address: CONEXANT SYSTEMS, INC., 4311 Jamboree Road, Newport Beach, CA, 92660, US

(21) Appl. No.: 09/790,359

(22) Filed: Feb. 21, 2001

(51) Int. Cl. G06K 9/00

(52) U.S. Cl. 382/151

(57) ABSTRACT

This method for aligning a slicing machine saw with saw streets of an array of units, such as a Multi-Chip Module printed circuit board, provides for initial alignment by reference to fiducial marks of the array. The alignment is refined by obtaining images of small portions of the array along the specific saw street to be cut, and analyzing the images to locate the features of the units adjoining each side of the saw street. The edges of the features adjoining the saw street are identified, and the saw is centered between the edges with a high degree of precision.

### BACKGROUND OF THE INVENTION

1. Field of the Invention

This invention relates to positioning and alignment of arrayed Multi-Chip Modules for singulation of the individual modules.

2. Background

An integrated circuit, or IC, is typically manufactured as a semiconductor die mounted on a leadframe or substrate that provides an electrical interface between the IC and external circuitry, and physical support for the die. The die and the substrate (or leadframe) are connected by wires or flip chip application and the entire assembly is encapsulated within a plastic mold cap, although ceramic and metal packages are also used in certain applications.

Multi-Chip Modules (“MCMs”) are small functional blocks containing, within a single package, a die or multiple dies, possibly with supporting components. Because of MCMs' small size, they have short internal connections and high operating speeds. They are becoming more popular because of the constantly increasing need for miniaturization and demand for higher operating frequencies. A good example of an MCM functional block is a combination of a microprocessor, memory, and associated control logic.

Printed circuit boards (“PCBs”) that serve as substrates for MCMs are fabricated in M by N arrays; often, there are several such arrays on a single PCB strip. FIG. 1 illustrates a representative strip 100 with four 3 by 5 arrays. (Hereinafter we use “strip” to refer to a piece of PCB with one or more arrays of individual circuits; a strip may have one or more rows and columns of arrays.) After individual circuits on a strip are populated with components (e.g., dies), the required electrical connections are made in each MCM by bonding wires between appropriate pads and die metalization areas or flip chip applications. The component side of the strip is then covered with a mold compound, such as plastic, to protect the circuitry. Finally, the MCMs are singulated, i.e., separated from each other, by cutting through the “saw streets” running between rows and columns of the arrays. For example, a vertical saw street runs along line 110 from area A to area B in FIG. 1A, in between two columns of MCM pads. A horizontal saw street runs along line 120 through areas C and D.

With the cost of PCB being substantially fixed for a particular design, the more individual devices are fabricated from a single fixed-size strip, the lower the cost of each individual device. Minimizing the width of the saw streets therefore improves the yield of devices per array of the PCB. Given a fixed width of the saw blade (or any cutting tool), typically about 250 micrometers, the controlling factor in determining the minimum saw street width is the alignment of the saw with the street. With precise alignment, little margin beyond the width of the blade need be provided for the sawing operation. Thus, if the saw blade is kept perfectly centered within the street, the yield is optimized. Potential for deviation from the center leads to increased pad to package offset, thereby decreasing the number of devices per array of the PCB, and increasing cost per device.

Existing wafer slicing machines are often used for MCM singulation, albeit with different programming and thicker blades than those used for semiconductor wafer processing. Workpiece (PCB strip) alignment with the saw of a wafer slicing machines involves determination of the displacement of the workpiece relative to the surface of the machine, and of the angular orientation of the strip relative to the surface. There are a number of known methods for calculating both parameters by reference to physical characteristics of the workpiece, and for positioning the workpiece on the surface for various fab operations, including singulation by sawing. Some of the methods are described in U.S. Pat. with the following U.S. Pat. No. 6,097,473 to Ota et al.; U.S. Pat. No. 6,038,029 to Finarov; U.S. Pat. No. 5,682,242 to Eylon; and U.S. Pat. No. 5,042,709 to Cina et al.

The physical characteristics used for alignment may be fiducial marks (or “fiducials”), created on the workpiece especially for that purpose. (Fiducials are marked with reference numeral 130 in FIG. 1A; note that only some fiducials are illustrated.) The slicing machines locate fiducials and then cut at pre-programmed locations relative to those fiducials.

The x and y dimensions of the individual devices, as well as the x and y pitches of the devices within the arrays, must be tightly controlled for at least two reasons. First, the devices are subject to dimensional tolerances to allow their subsequent processing in test equipment, and to enable automated placement of the MCMs on customers' boards. Second, variations in pitch (i.e., offsets of the devices in the x and y dimensions) cause deviation of the saw streets from the saw streets computed by reference to the strip's features, such as fiducials. Even if the saw is perfectly centered in the saw street when cutting begins, deviation in pitch from programmed value causes deviation of the saw from the center as the cutting progresses along the saw street. For illustration of the deviation from the center of the saw street, see detail areas A and B in FIG. 1B, and detail areas C and D in FIG. 1C.

Because experience has shown that blind reliance upon fiducials is often inadequate, many manufacturers position and align saws of their slicing machines by reference to other features of a particular strip. For example, the camera of the slicing machine would focus on area E of the strip shown in FIG. 1, and the video processor would then attempt to match the expected pattern of lands to the image obtained by the camera; the centroid of the matched image becomes a point of reference on the strip. This approach, although an improvement over the use of the fiducials for positioning and alignment, also suffers from imprecision due to the pitch variation discussed above.

It is therefore desirable to provide a better method for centering the saw within saw streets.

### SUMMARY OF THE INVENTION

The invention is a novel method for centering a saw of an MCM singulation apparatus within saw streets of an MCM strip. For example, locations of the MCM features are obtained by analyzing images taken by a camera of a slicing machine. To improve speed of the singulation process, two points in each of two locations of a saw street may be examined to determine the saw street's centerline; each location's points may be on the opposite sides of the street. A centerline of the saw street may then be defined by a first point equidistant to the points of the first location, and a second point equidistant to the points of the second location. Alternatively, a plurality of locations may be analyzed, and a best fit approximation for the centerline may be computed therefrom. Pursuant to another method according to this invention, a plurality of points is analyzed, and the alignment of the saw is corrected at the beginning of each segment of the street by reference to the endpoints of the segment, resulting in the best fit of the street. These and other objects of the invention may be obtained by reading the following specification along with the drawings that are appended hereto. The protection sought by the inventor may be gleaned from a fair reading of the claims that conclude this specification.

### BRIEF DESCRIPTION OF THE DRAWING

FIG. 1A, described above, illustrates a printed circuit board with four 3 by 5 arrays of Multi-Chip Modules separated by saw streets.

FIG. 1B illustrates the effect of pitch variation and of other imperfections on sawing along a vertical saw street computed by reference to fiducials of the board.

FIG. 1C illustrates the effect of pitch variation and of other imperfections on sawing along a horizontal saw street computed by reference to fiducials of the board.

### DETAILED DESCRIPTION

In an embodiment according to the present invention, a PCB strip and a saw are first brought into approximate alignment for the cutting operation. This initial alignment is accomplished by any of the conventional techniques; the specific method used is not critical. Thereafter, the strip's surface opposite component side is scanned in the immediate vicinity of the specific saw street being cut, and the scan is analyzed to determine the precise locations of the pad edges of the devices adjoining the saw street. When the precise locations of the pad edges on both sides of the street are known, the saw is centered between them.

The scan may be obtained in the visual or infrared spectrum. In an embodiment, the scan is made by a charge coupled device (“CCD”) camera mounted on the slicing machine. A pattern recognition program is employed to match the expected features to the image obtained. Many conventional pattern recognition algorithms can be used for this purpose. The exact one employed is not critical, as long as it can locate the edges of the features with sufficient precision, and image processing is reasonably fast. By way of example, the following books and publications describe several useful pattern recognition methods: Jurgen Schurmann, A Unified View of Statistical and Neural Approaches (John Wiley & Sons 1996); Terry Caelli & Walter F. Bischof, Machine Learning and Image Interpretation (Plenum Pub. Corp. 1997); Keinosuke Fukunaga, Introduction to Statistical Pattern Recognition (Academic Press 1990); Handbook of Pattern Recognition and Image Processing (Tzay Y. Young and King-Sun Fu eds. 1997); U.S. Pat. No. 5,619,596 to Iwaki et al.; and U.S. Pat. No. 5,568,568 to Takizawa et al.

Only those areas adjacent to the particular saw street being cut need to be examined. Thus, the image captured and analyzed may be of a relatively small area. Limiting image processing to a small area decreases the need for computational resources and increases throughput of the slicing machine.

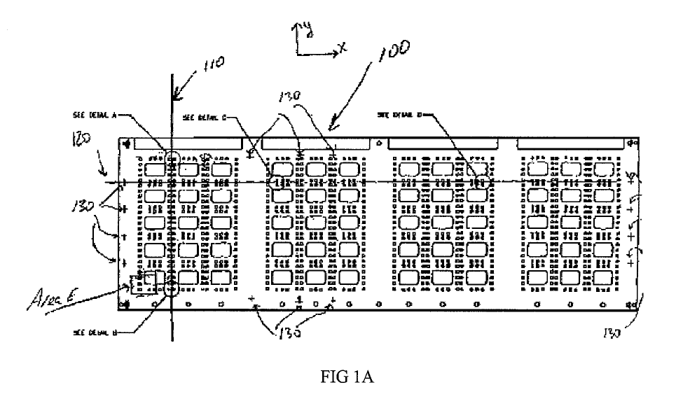

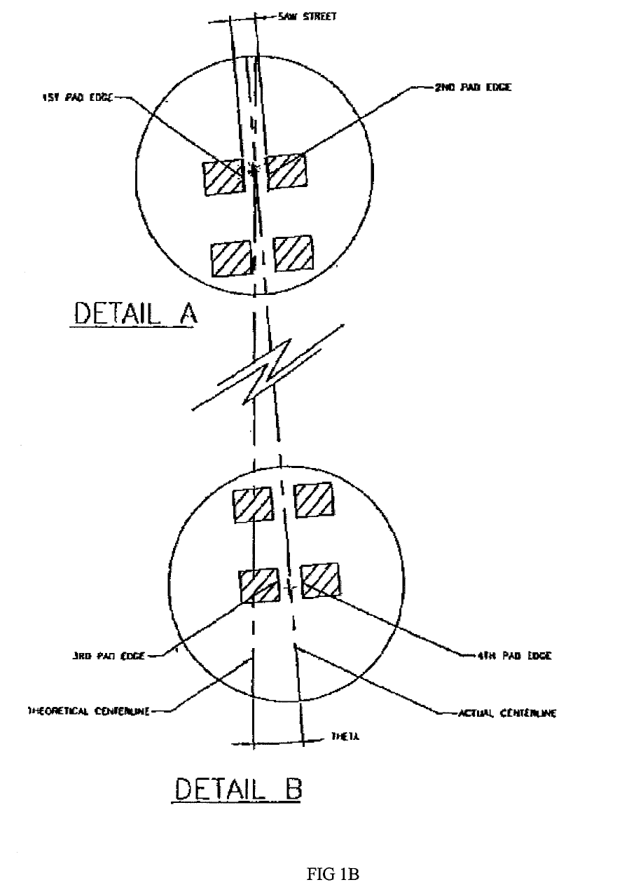

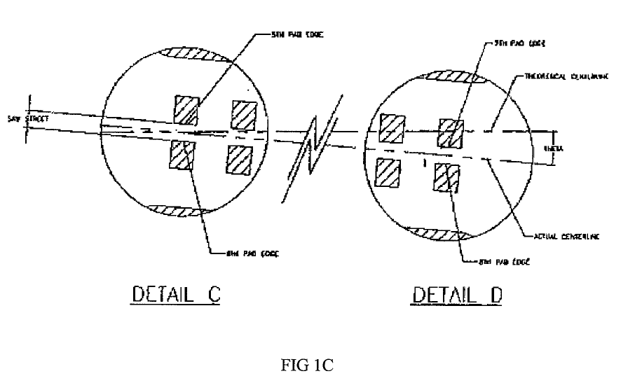

A saw street's centerline is ideally a perfect line. A line, of course, can be fixed by two points in the line's plane. For the shorter dimension of the strip (the vertical dimension in FIG. 1A), it is usually preferable to fix the centerline by its endpoints, such as points within detail areas A and B. In the longer dimension (the horizontal dimension in FIG. 1A), the strip sometimes warps during the manufacturing process, causing the saw streets running in the corresponding direction to become bowed. It therefore may be preferable to use non-endpoints for fixing the horizontal saw street centerlines. This is illustrated by using points within areas of detail C and D of FIG. 1A. Note that these two points are approximately equidistant from the horizontal edges and the center of the strip.

More than two points can be used to improve the alignment of the saw with the centerline. For example, given a plurality of points, the best fit can be determined for a straight line by minimizing root-mean-square of the deviations of the points from the line. Other error functions can be used.

From the above description of the invention it is manifest that various equivalents can be used to implement the concepts of the present invention without departing from its scope. Moreover, while the invention has been described with specific reference to certain embodiments, a person of ordinary skill in the art would recognize that changes could be made in form and detail without departing from the spirit and the scope of the invention. In particular, the same principles as described with reference to MCM singulation may be applied to singulation of dies from a semiconductor wafer. The described embodiments are to be considered in all respects as illustrative and not restrictive. It should also be understood that the invention is not limited to the particular embodiments described herein, but is capable of many equivalents, rearrangements, modifications, and substitutions without departing from the scope of the invention.

What is claimed is:

1. A method for aligning a cutter and a first saw street of a PCB strip with multiple circuits, each circuit having features, the method comprising the steps of:
centering the cutter in relation to the first saw street by reference to one or more of the features and fiducials of the strip;
determining locations of edges of the circuits adjoining each side of the first saw street; and
aligning the cutter in the first saw street by reference to the locations of the edges.

2. The method according to claim 1, wherein said step of determining locations includes the steps of:
obtaining an image of the strip; and
matching the image to an expected pattern of the strip by employing a pattern recognition algorithm.

3. The method according to claim 2, wherein the pattern recognition algorithm processes only those portions of the image that adjoin the first saw street, the portions being situated closer to the first saw street than to any other saw street of the strip.

4. A method for determining a fine centerline of a first saw street of a PCB strip with multiple circuits, each circuit having features, the method comprising the steps of:
obtaining a coarse centerline of the first saw street by reference to one or more of the features and fiducials of the strip;
selecting a first area of detail and a second area of detail along the coarse centerline, each of the areas including some of the features on each side of the coarse centerline;
determining locations of edges of the features adjoining each side of the coarse centerline at each of the areas;
selecting a first point in the first area, the first point being substantially equidistant from the edges of the features adjoining each side of the coarse centerline in the first area;
selecting a second point in the second area, the second point being substantially equidistant from the edges of the features adjoining each side of the coarse centerline in the second area; and
assigning a line connecting the first and the second point to be the fine centerline.

5. A method for determining a fine centerline of a first saw street of a PCB strip with multiple circuits, each circuit having features, the method comprising the steps of:
obtaining a coarse centerline of the first saw street by reference to one or more of the features and fiducials of the strip;
selecting a plurality of areas of detail along the coarse centerline, each of the areas including some of the features on each side of the coarse centerline;
determining locations of edges of the features adjoining each side of the coarse centerline at each of the areas;
selecting, in each area, a point substantially equidistant from the edges of the features adjoining each side of the coarse centerline in said each area;
defining an error function whose value depends on distances between each said point and an argument line; and
selecting a fine centerline to minimize the value of the error function of the fine centerline.

6. An apparatus for singulating array devices of a PCB strip by sawing along saw streets of the PCB strip, the apparatus comprising:
a controller;
a surface for fixing the strip;
a saw;
a mechanism for effecting relative movement between the surface and the saw under supervision of the controller;
a sensor for determining approximate relative position and orientation of the strip and the surface by reference to features of the strip, and for sending the approximate relative position and orientation to the controller;
a unit for positioning the mechanism under supervision of the controller;
an optical system for obtaining images of the strip under supervision of the controller; and
a processing unit for receiving the images and matching them to pre-stored patterns, said processing unit producing an output of precise relative position and orientation of the strip and the surface and sending the precise relative position and orientation to the controller;
whereby the controller aligns the saw with a first saw street of the strip by reference to the approximate relative position and orientation received from the sensor, directs the optical system to obtain a first image, and aligns the saw with the first saw street by reference to the precise relative position and orientation received from the processing unit.

7. Apparatus for singulating array devices of a strip along saw streets of the strip, the apparatus comprising:
a saw for cutting the strip;
means for effecting relative movement between the strip and the means for cutting;
means for determining approximate relative position and orientation of the strip and the means for cutting by reference to features of the strip;
means for obtaining images of the strip;
means for matching the images to pre-stored patterns of the strip's features to determine a precise relative position and orientation of the strip and the means for cutting; and
means for centering the means for cutting in a saw street of the strip in accordance with outputs of the means for determining and means for matching.

8. Apparatus for singulating array devices according to claim 7, wherein the means for matching comprises means for executing a visual pattern recognition algorithm.

9. Apparatus for singulating array devices according to claim 8, wherein the means for executing comprises means for executing a visual pattern recognition algorithm based on relative location of dark and light areas in images compared by the algorithm.

10. A method for adapting a slicing machine for singulation of array devices of a PCB strip, each device having features, the array devices being separated by saw streets, the method comprising the step of modifying the machine's program sequence to perform the following steps:
aligning a cutter of the slicing machine in a first area of a first saw street by reference to one or more of the features and fiducials of the strip;
using a pattern recognition algorithm to determine locations of edges of the devices adjoining each side of the first saw street within the first area; and
centering the cutter in the first saw street within the first area by reference to the locations of the edges.

11. An automatic method for aligning a cutter and a saw street of a PCB strip with multiple circuits, each circuit having features, the method comprising the following steps performed under program control of a singulation machine:
step for centering the cutter in relation to the saw street by reference to one or more physical characteristics of the strip;
step for determining locations of edges of circuits adjacent to each side of the saw street; and
step for aligning the cutter with the center of the saw street by reference to the locations of the edges, said step for aligning performed after said steps for centering and determining.

12. The automatic method for aligning according to claim 11, wherein said step for determining comprises the following steps:
step for obtaining an image of a portion of the strip adjoining the saw street, the portion being situated closer to the saw street than to any other saw street of the strip; and
step for matching the image to an expected pattern of the portion by employing a pattern recognition algorithm.

13. A method for aligning a cutter and a first saw street of a wafer with multiple circuits, each circuit having features, the wafer having fiducials, the method comprising the steps of:
centering the cutter in relation to the first saw street by reference to one or more of the features and fiducials of the wafer;
determining locations of edges of the circuits adjoining each side of the first saw street; and
aligning the cutter in the first saw street by reference to the locations of the edges.

14. The method according to claim 13, wherein said step of determining locations includes the steps of:
obtaining an image of the wafer; and
matching the image to an expected pattern of the wafer by employing a pattern recognition algorithm.

15. The method according to claim 14, wherein the pattern recognition algorithm does not process portions of the image that are situated farther from the first saw street than from any other saw street of the wafer.

16. A method for determining a fine centerline of a first saw street of a semiconductor wafer with multiple circuits, each circuit having features, the wafer having fiducials, the method comprising the steps of:
obtaining a coarse centerline of the first saw street by reference to one or more of the features and fiducials of the wafer;
selecting a first area of detail and a second area of detail along the coarse centerline, each of the areas including some features on each side of the coarse centerline;
determining locations of edges of the features adjoining each side of the coarse centerline at each of the areas;
selecting a first point in the first area, the first point being substantially equidistant from the edges of the features adjoining each side of the coarse centerline in the first area;
selecting a second point in the second area, the second point being substantially equidistant from the edges of the features adjoining each side of the coarse centerline in the second area; and
assigning a line connecting the first and the second point to be the fine centerline.

17. A method for determining a fine centerline of a first saw street of a semiconductor wafer with multiple circuits, each circuit having features, the wafer having fiducials, the method comprising the steps of:
obtaining a coarse centerline of the first saw street by reference to one or more of the features and fiducials of the wafer;
selecting a plurality of areas of detail along the coarse centerline, each of the areas including some features on each side of the coarse centerline;
determining locations of edges of the features adjoining each side of the coarse centerline at each of the areas;
selecting, in each area, a point substantially equidistant from the edges of the features adjoining each side of the coarse centerline in said each area;
defining an error function whose value depends on distances between each said point and an argument line; and
selecting a fine centerline to minimize the value of the error function of the fine centerline.

18. An apparatus for singulating dies of a semiconductor wafer by sawing along saw streets of the wafer, the apparatus comprising:
a controller;
a wafer holder;
a saw;
a mechanism for effecting relative movement between the holder and the saw under supervision of the controller;
a sensor for determining approximate relative position and orientation of the wafer and the holder by reference to features of the wafer, and for sending the approximate relative position and orientation to the controller;
a unit for positioning the mechanism under supervision of the controller;
an optical system for obtaining images of the wafer under supervision of the controller; and
a processing unit for receiving the images and matching them to pre-stored patterns, said processing unit producing an output of precise relative position and orientation of the wafer and the surface and sending the precise relative position and orientation to the controller;
wherein the controller aligns the saw with a first saw street of the wafer by reference to the approximate relative position and orientation received from the sensor, directs the optical system to obtain a first image, and aligns the saw with the first saw street by reference to the precise relative position and orientation received from the processing unit.

19. Apparatus for singulating dies of a semiconductor wafer along saw streets of the wafer, the apparatus comprising:
means for cutting the wafer;
means for effecting relative movement between the wafer and the means for cutting;
means for determining approximate relative position and orientation of the wafer and the means for cutting by reference to features of the wafer;
means for obtaining images of the wafer;
means for matching the images to pre-stored patterns of the wafer's features to determine a precise relative position and orientation of the wafer and the means for cutting; and
means for centering the means for cutting in a saw street of the wafer in accordance with outputs of the means for determining and means for matching.

20. Apparatus for singulating dies according to claim 19, wherein the means for matching comprises means for executing a visual pattern recognition algorithm.

21. Apparatus for singulating dies according to claim 20, wherein the means for executing comprises means for executing a visual pattern recognition algorithm based on relative locations of dark and light areas in images compared by the algorithm.

22. A method for adapting a slicing machine for singulation of dies of a semiconductor wafer, each die having features, the dies being separated by saw streets, the wafer having fiducials, the method comprising the step of modifying the machine's program sequence to perform the following steps:
aligning a cutter of the slicing machine in a first area of a first saw street by reference to one or more of the features and fiducials of the wafer;
using a pattern recognition algorithm to determine locations of edges of the devices adjoining each side of the first saw street within the first area; and
centering the cutter in the first saw street within the first area by reference to the locations of the edges.

23. An automatic method for aligning a cutter and a saw street of a semiconductor wafer with multiple circuits, each circuit having features, the method comprising the following steps performed under program control of a singulation machine:
step for centering the cutter in relation to the saw street by reference to one or more physical characteristics of the wafer;
step for determining locations of edges of the circuits adjacent to each side of the saw street; and
step for aligning the cutter with the center of the saw street by reference to the locations of the edges, said step for aligning performed after said steps for centering and determining.

24. The automatic method for aligning according to claim 23, wherein said step for determining comprises the following steps:
step for obtaining an image of a portion of the wafer adjoining the saw street, the portion being situated closer to the saw street than to any other saw street of the wafer; and
step for matching the image to an expected pattern of the portion by employing a pattern recognition algorithm.
